(19) United States
(12) Patent Application Publication
(10) Pub. No.: US 2022/0138407 A1
(43) Pub. Date: May 5, 2022

(54) Document Writing Assistant with Contextual Search Using Knowledge Graphs

(71) Applicant: Giving Tech Labs, LLC, Seatte, WA (US)

(72) Inventors: Luis Salazar, Kirkland, WA (US); Ying Li, Bellevue, WA (US)

(73) Assignee: Giving Tech Labs, LLC, Seattle, WA (US)

(21) Appl. No.: 17/084,569

(22) Filed: Oct. 29, 2020

(51) Int. Cl. G06F 40/169; G06F 40/186; G06N 5/02; G06F 16/901; G06F 40/103; G06F 16/93

(52) U.S. Cl. CPC G06F 40/169; G06F 40/186; G06F 16/93; G06F 16/9024; G06F 40/103; G06N 5/022

(57) ABSTRACT

A writing assistant may compare the context and structure of a document being written with a preexisting knowledge graph. The comparison may highlight overlaps, differences, and other comparisons that may assist an author. A document graph may be extracted from the author's words and other context, so that a search of the knowledge graph has a deep, rich context for the search. A document graph may include hierarchies, topics, and relationships between different elements. The document graph may identify elements as nodes and relationships as edges of the graph. In some cases, the document graph may include additional contextual information, such as information about the author, external organizations associated with the document, other context about the document itself. The comparison of the document graph with other knowledge graphs may be presented alongside an editing window, such that the comparisons may assist the author during document creation and editing.

### BACKGROUND

Every knowledge domain has its own set of trusted sources. From specific diseases to automotive repair, each knowledge domain has individual humans that are experts, as well as organizations, publications, books, or other sources of knowledge. Sometimes, these knowledge sources have formal review processes, like peer reviewed journals, while other sources are community sourced and reviewed, like Wikipedia or even chat boards where community members share questions and answers.

Knowledge domains may be constructed from common keywords and topics, but also may be strongly informed by other types of relationships. These relationships may be business relationships, such as supplier/consumer relationships between companies, funder/recipient relationships in non-profits, medical provider/patient relationships, and other such relationships.

### SUMMARY

A writing assistant may compare the context and structure of a document being written with a preexisting knowledge graph. The comparison may highlight overlaps, differences, and other comparisons that may assist an author. A document graph may be extracted from the author's words and other context, so that a search of the knowledge graph has a deep, rich context for the search. A document graph may include hierarchies, topics, and relationships between different elements. The document graph may identify elements as nodes and relationships as edges of the graph. In some cases, the document graph may include additional contextual information, such as information about the author, external organizations associated with the document, other context about the document itself. The comparison of the document graph with other knowledge graphs may be presented alongside an editing window, such that the comparisons may assist the author during document creation and editing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing a document graph-based query.

FIG. 2 is a diagram illustration of an embodiment showing a network environment a document graph extractor and knowledge graph search engine.

FIG. 3 is a flowchart illustration of an embodiment showing a method for creating a document graph and performing a search against a knowledge graph.

FIG. 4 is a diagram illustration of an example embodiment showing interactions with an author using the search results.

FIG. 5 is a flowchart illustration of an embodiment showing a method for searching using a document graph and identifying missing elements.

FIG. 6 is a flowchart illustration of an embodiment showing a method for determine whether a result was relevant to an author.

### DETAILED DESCRIPTION

Writing Assistant Using Knowledge Graph

A writing assistant may take a user's input and identify suggestions by searching a knowledge graph. One use case may be a user who is typing a research report on a word processor. As the user writes, a document graph may be constructed from the key phrases, concepts, or other parts of the text. The document graph may be used to search a larger knowledge graph, and the search results may be surfaced to the author.

The writing assistant may create a document graph that defines topics or elements and relationships between the topics. The document graph may be represented by topics as nodes on the graph and relationships as edges connecting the nodes. The document graph may be supplemented by external information, such as information about the author or authors, other documents written by the author, context provided by the author or the group of authors, related to their intention while creating such document, or context inferred from their behavior such as search patterns, words preferences, or related to the current document, and so on. In some cases, a document template may be used, and such a template may include predefined elements that an author may include with their writing.

Searches performed during the editing process may use the entire document as context for the search. A common keyword search on a conventional search engine will find popular websites for that keyword, but a contextual search using a document graph will use the entire document, as well as the author's declared or observed intent as context for the search.

For example, a 2,000 word document may have several paragraphs and may be organized under different headings and subheadings. As an author works on a paragraph within the heading/subheading structure, a document graph may be populated with the concepts discussed in the different sentences and paragraphs; it may be populated also with concepts related to the intent of the authors, even if the intent is not part of the 2,000 words in the document; for example, the authors declared or observed intent is to write a grant proposal, hence, the graph is populated with concepts related to both: the 2,000 words written, and the declared intent of writing a grant proposal. The document graph may illustrate the context in which the author's current paragraph exists, and a search may be performed against the knowledge graph using that context.

The results of the search may pinpoint extremely relevant information for the author at that point in time, working on that specific sentence within that specific paragraph within that specific document structure. The context of the search as derived from the document graph can be much more relevant than conventional keyword searches performed on conventional internet search engines, because on this case the search results are informed by both content and context and context is both declared and observed or inferred.

When the searches are performed against knowledge graphs, especially curated, specialized knowledge graphs specific to the domain of the document and author, the search results can be extraordinarily helpful. For example, a grant writer may be working on a grant proposal. The grant proposal may be for a specific funding source and for a goal the funding source has defined. A knowledge graph of that funding goal may be derived from scientific papers, journal articles, trusted news sources, and other sources all related to the funding goal. Even if the written document does not include keywords related to a grant proposal, the context is declared by the author or inferred from their behavior, and searches performed against that knowledge graph for that author will return search results tailored to the language, issues, and domain knowledge of that funding goal or topic of the grant.

A “document” may be a compilation of multiple documents. For example, a book may be composed of individual documents for each chapter of a book. In another example, an author's full body of work on a topic may be aggregated together into a “document” and used to search various knowledge graphs. In yet another example, a website might be considered a “document” while an author may be one person working on a post, entry, or other element of the entire website.

The term “author” is often used in this specification and claims to refer to a single person, but also includes uses where multiple authors collaborate on a document. Some complex documents may include multiple authors, editors, copywriters, fact checkers, and other people who contribute, and each person's actions are meant to fall under the larger heading of “author.”

The writing assistant may capture key phrases or concepts and may present helpful snippets or summaries for the user. The writing assistant may identify the phrases or concepts within the context of other text within the writing. For example, a paragraph, section, or chapter of the text may be used to identify the overarching concept of the written piece, as well as sub-topics, concepts, or arguments made by the writer.

As a writer works on their text, the writing assistant may perform searches using relevant portions of the writer's text as input. The input may be the most current portions of the text being entered or edited, as well as the context for that word, phrase, or sentence. The historical editing of the document by an author or group of authors is also taken into account as a form of input. If the author or group of authors rejected or accepted specific search results in the past, or deleted a term in the past, those actions inform the search results and each action becomes part of the knowledge graph itself.

For example, a thesaurus or dictionary assistant may identify a particular phrase by the writer and may suggest alternative phrases or helpful definitions to the user. In one example, a writer may be creating a blog post within a specific technical domain, such as a specific childhood disease. Within that specific knowledge domain, there may be commonly used words or phrases that have meaning within that domain. Virtually all knowledge domains have their own lexicography, which help practitioners communicate more effectively.

In the example, a writer may use a term that may not be the commonly used terminology within the field. The knowledge graph may be consulted to present one or more options to the user for common terminology within the field. Further, technical definitions, examples of uses of the phrase, or other aids may be presented to the writer. From these options, a writer may select one that best fits the writer's intent.

In the example, an author or group of authors may be experts in a specific childhood disease, but have declared that their target audience for the document they are creating, is families and caregivers of children with such disease. In this case, the knowledge graph will be consulted to present alternative lay-person terms that are easier to understand by a non scientific audience.

The author or group of authors may be presented with a user interface to accept or not the proposed alternative terms or any suggestion proposed by the knowledge graph, and the action taken by the authors or group of authors, become part of the knowledge graph as entities or nodes.

In such an example, the document's knowledge graph may be compared against other knowledge graphs to find similar or compatible terms for a concept. In such cases, a concept may be presented using several different terms, where each term may be appropriate for a specific audience.

In another example, a writer may be describing a concept that may be in a knowledge graph. As the writer types, a search may find articles, blog posts, publications, or other information about the concept, and these references may be presented to the writer. The writer may be able to expand and navigate to the references, copy links or citations from the references, or cut and paste portions of the references into the document being written.

The writing assistant may combine the acts of writing a document and performing research about the topic into one user experience. As the user writes, a knowledge graph may be consulted to surface helpful elements that may be incorporated into and thereby improve the document.

The writing assistant may be deployed in any authoring scenario, from research academics writing highly technical articles for a scientific journal to a blogger writing a quick blog post, to a businessperson drafting an email to a customer, to a person writing a text to a friend.

The knowledge graphs used by a writing assistant may be developed for specific knowledge domains. The knowledge domains may be cultural or social domains, scientific technical domains, topical domains, or any other domain of knowledge, including religious, language, political, or other classification or grouping of knowledge domains.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

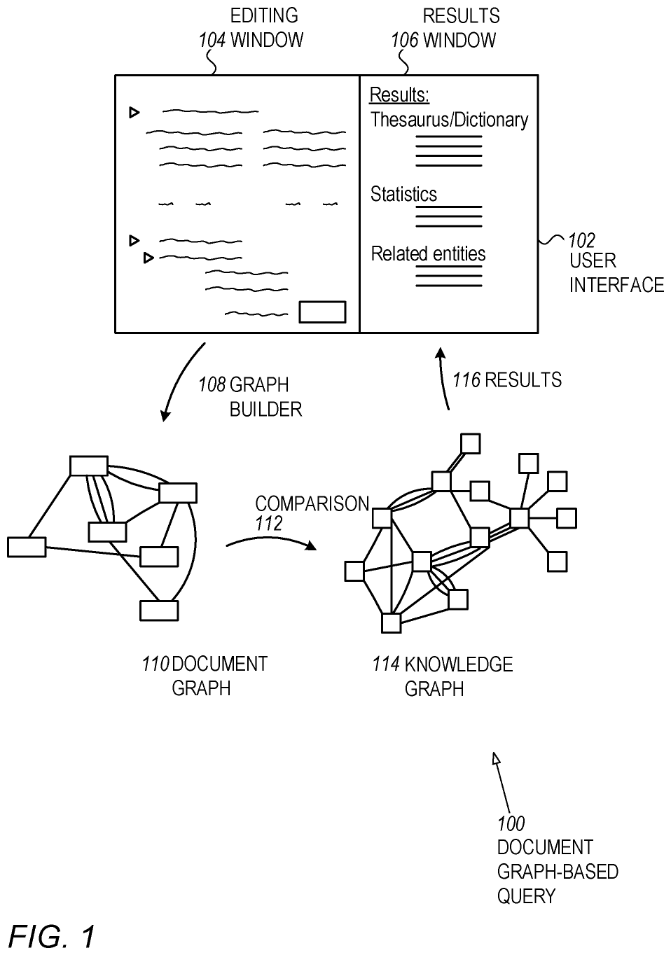

FIG. 1 is a diagram illustration showing embodiment 100, a document editor that has a search engine based on a document's knowledge graph. Embodiment 100 illustrates one way that a document graph may be extracted from a document, then used to search a knowledge graph. The search may use the context of the document, as defined in the document graph, to find similarities and differences with a knowledge graph. The knowledge graph may represent a corpus of knowledge for a general or specific domain, typically a domain related to the document being created.

Embodiment 100 is merely one example of how a document graph may be used as input to search a knowledge graph. In the example, an editing window 104 and a results window 106 are presented to a user. The user may type into the editing window 104 to add, delete, or otherwise edit text in the document being displayed, and results from a search may be displayed in the results window 106. In some cases, the results window 106 may be updated in real time as the user makes additions or changes to the document, while in other cases, the results may be updated periodically or on demand.

The example of embodiment 100 illustrates an example of a user editing a document in a conventional word processing application. However, other examples may include any user interface where text may be edited. Such examples may include creating or editing electronic mail, creating or editing Short Messaging System (SMS) messages or other communication services, creating or editing text within a website or blog, or any other text creation and editing scenario. For the purposes of this specification and claims, the example of a word processor application is used to highlight different features, however, such features may be applied to any other text creation and editing scenario.

An editing window 104 may be a user interface component where text may be entered and edited. Text may be typed in, cut and pasted, or some other mechanism may be used to enter and edit text.

In some cases, a document may have formal or informal structure. For example, a system of headings, subheadings, quotations, sidebars, or other formatting may imply a structure of the document. A user may be able to add headings, increase or decrease a heading's level within an outline structure, or otherwise create and manipulate the structure.

A document may be created with a template. A template may include headings, formatting, styles, and in some cases, pre-filled text. The text may be placeholder text or may include text that may become part of the finished document.

A document's structure may be used as elements for a document graph. Headings, forwards, introductions, or other elements may define a document's overall structure and general scope, while lower level headings or other elements may be more detailed in their focus. Information relating to a higher level heading may be imputed or implied to relate to lower level headings under the higher level heading. In such a manner, the information of higher level headings creates context for the lower level content.

A graph building 108 may extract elements from the document in the editing window 104 to create a document graph 110. The document graph 110 may contain nodes that represent elements, concepts, topics, or other parts of the document. Edges of the document graph 110 may represent relationships between the nodes. In some cases, various elements may have multiple relationships between them. Each relationship may include a weight or strength indicator, where the importance of the relationship may be measured. Some systems may include a positive or negative relationship strength which may indicate the attraction or repulsion between the nodes.

The document graph 110 may be updated as a user adds, removes, or edits the document in the editing window 104. In some embodiments, the document graph 110 may be updated at various intervals. Some embodiments may update only when a user pauses typing, for example, while other embodiments may update when the user requests an update.

A comparison 112 may be made between the document graph 110 and a knowledge graph 114.

A knowledge graph 114 may be a graph of a specific or general domain, and in some cases, multiple knowledge graphs 114 may be searched for a single document graph 110. Knowledge graphs 114 may represent structured knowledge from a domain. The knowledge graphs 114 may be structured in a similar manner as the document graph 110, with nodes representing concepts, elements, topics, or other components, and edges representing relationships between those components. The relationships may be weighted, have positive or negative indicators, or otherwise capture the interactions or relationships between knowledge elements.

In many cases, a knowledge graph 114 may include sources for information contained in the graph. For example, a relationship in the knowledge graph 114 between two elements may include a link to a source document where such a relationship may have been identified. In such a graph, a search of the graph that might highlight that relationship may allow a user to find the source document. Such a search may allow the user to add a link to the source document in the document being created, but also may allow the user to visit and read the source document.

The comparison 112 between the document graph 110 and knowledge graphs 114 may highlight consistencies and overlaps between the two graphs, as well as inconsistencies or missing elements between the graphs. The comparison 112 may map the document graph 110 over the knowledge graphs 114 to find matches as well as missing elements. The results may be displayed in several different forms, which may assist the author in writing their document.

The results 116 may be displayed in a results window 106 within the user interface 102. In the example, the results may include a thesaurus or dictionary for technical terms, statistics related to the topic being discussed, and various related entries. The author may be able to interact with the results 116 shown in the results window 106 by clicking on different elements to dive deeper into the topic, show source materials, find related information about the topics, and so forth.

An editing window 104 may be used to identify elements for a search. In one use case, the author may be typing new text and the search input may be the background context of the entire document, with an emphasis on the last portion being typed. In this use case, the current sentence, paragraph, section, heading, or other elements may be context with the specific query being the topic being discussed in the current sentence or paragraph. This use case may present information from the knowledge graph that may help the author compose their thoughts by offering information relevant to the specific sentence, but within the entire context of the document.

In another use case, an author may select a portion of text, such as highlighting a word, phrase, sentence, paragraph, or other portion. That portion may be used as a query for the knowledge graph, and the search results may reflect the highlighted text within the context of the entire document.

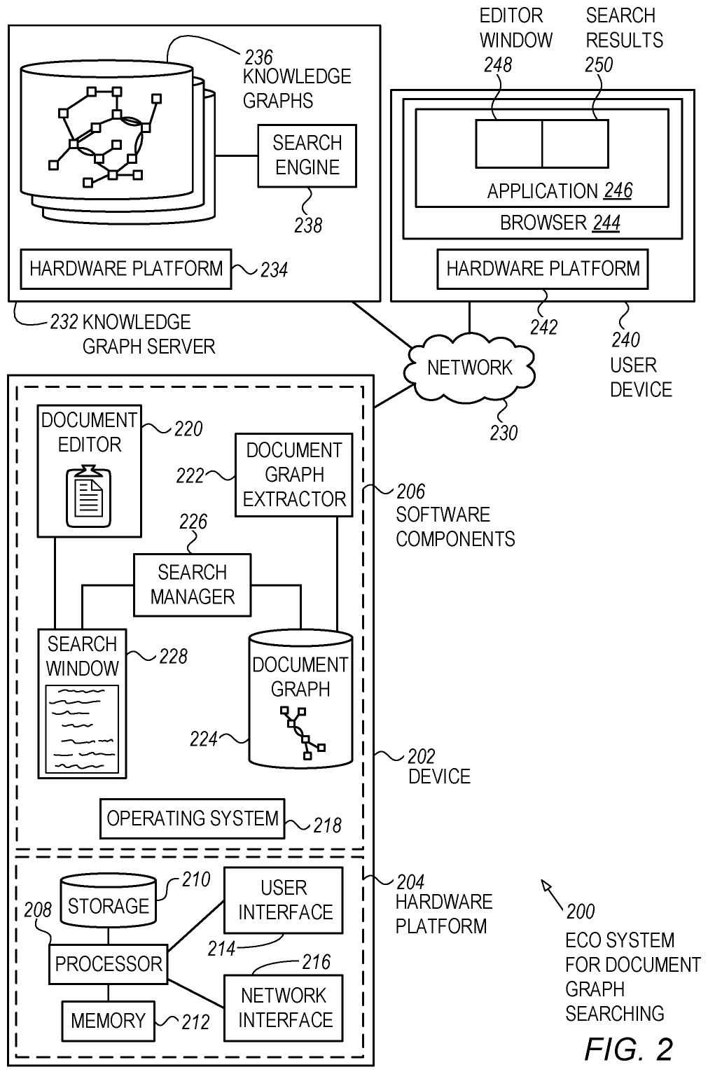

FIG. 2 is a diagram of an embodiment 200 showing components that may deploy document graphs to provide contextual search assistance for an author working on a text-based document. Embodiment 200 is merely one example of an architecture that may help an author create, edit, and refine a document.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

A document editor 220 may be an application through which a user creates and edits a document, typically a text-based document. The document editor 220 may be a full-featured word processor or may be a lightweight editor that may not include sophisticated features. In many cases, the document editor 220 may be a graphical editor where formatting, structure, and other elements may be applied to the text.

The document editor 220 may be any type of editor for text, and the document being edited may be any type of text. In a conventional word processor use case, the full document may be loaded into a word processor and the author may be able to edit any portion of the document.

In some use cases, the term “document” may include other sources of information about the author's task, each of the sources may add to the context or background of the document. For example, the context of the editing may include multiple files, each of which may have some relationship to the text being edited. The context may include information about the author, as well as information about other authors that may have contributed to the document. The context may include archives, data sources, previous versions, related articles or documents, libraries of sources, and other information. The context may be a framework from which searches may be performed.

In another use case, the document may be an electronic mail or email. The context for the document or email being edited may be the conversation history between the author and the recipients. In a use case of an SMS message editor, the context may be the dialogue history of communications.

A document graph extractor 222 may analyze the document being edited and may create a document graph 224. The document graph extractor 222 may take the text within the document, aggregate that text with additional context, and build a document graph 224.

A search manager 226 may compare the document graph 224 with a set of knowledge graphs 236 to present results in a search window 228. The search window 228 may be presented to the author, and the search window 228 may have various functions for the author to navigate the results, dig deeper into specific items, organize and select the type of results being displayed, cut and paste information into the document, or perform other functions.

The device 202 may communicate across a network 230 to a knowledge graph server 232. The knowledge graph server 232 may operate on a hardware platform 234 and may contain one or more knowledge graphs 236. A search engine 238 may receive queries in the form of a document graph or section of a document graph, and may return information that may be displayed on a search window 228.

In general, a search engine 238 may receive a portion of a graph with some elements being the focus of a search and other elements being background or context of the search. The focused elements may be the specific elements and relationships where a high degree of similarity may be requested, with the background of context elements have a low degree of similarity.

One use case of the device 202 may be a system where a word processor application may operate on a user's device. Other use cases may separate the various functions to separate devices. One such example may be a user device 240, where a user may access the document editor 220 through an application 246 operating within a browser 244. Such an example is merely one configuration.

In the example of the user device 240, a hardware platform 242 may execute a browser 244 in which an application 246 may be displayed. The application 246 may have an editor window 248 and a search results window 250. In this example, the application 246 may include components of the document editor 220 and search window 228, which may be generated by the device 202 and transmitted to the user device 240. In such an example, an author may interact on one device while a second device, in this case device 202, may perform some or all of the various functions of editing a document, generating a document graph, and displaying search results.

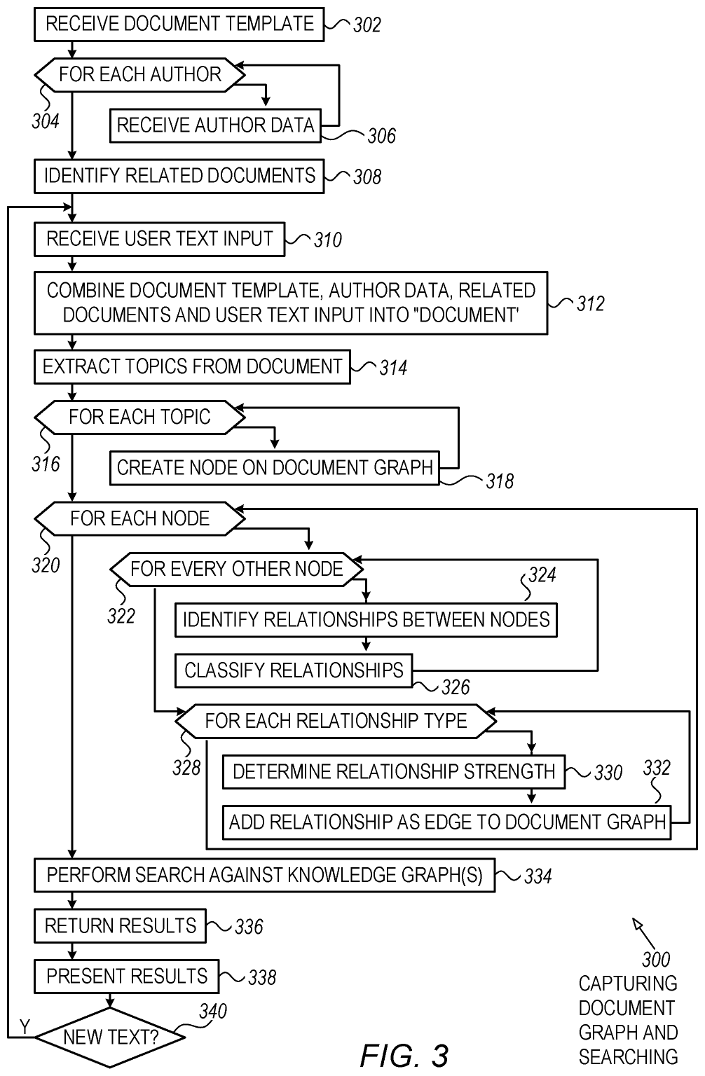

FIG. 3 is a flowchart illustration of an embodiment 300 showing a general method of processing a document and retrieving and displaying search results. The operations of embodiment 300 may represent those performed by a device that may receive edits and process search results, such as the device 202 in embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The process of embodiment 300 may gather information about a document being edited, including background information from one or more authors, as well as related documents. These data sources may generate background information or context in which an author's work may be generated into a document graph.

At the beginning stages of document creation, an author may not have created a sizeable corpus of text from which a meaningful document graph may be created. By gathering background information, a more meaningful starting point may be created. The author's background and history may be useful, such as their native and secondary languages, educational background, work history, reading history, and other data may inform a background or context for their writing.

Other documents may be identified that may be relevant to the document being created. For example, a blog article for a website may include some or all of the existing blog posts as background documents to give context to a new blog post being written. In another example, an author's writings on a general topic may be identified as background information.

All of the background information may be used, along with the author's currently written text, into a document graph. The document graph may have topics, elements, subjects, operations, statistics, or other elements extracted from the writing and background as nodes, and relationships between those elements as edges. The document graph may be compared against the knowledge graph to generate search results.

In block 302, a document template may be received. A document template may be in any form, and may include text, text placeholders, formatting, hierarchical structures, and other elements. In some cases, a document template may include descriptions of the type of material to be entered at different areas of the document, such as a book report template that may include sections on important characters, for example.

Some documents may have multiple authors, while many documents may only have one. For each author in block 304, author data may be received in block 306. The author data in block 306 may include background information about the authors which may give context for the document being generated. For example, a set of authors may include people from engineering or science disciplines, and the author's technical background may provide context for their interests, level of sophistication, and manner for describing things.

Related documents may be identified in block 308. A related document may be any document that may provide context for the document being written. In an example of a large book, each chapter may be found in a different document file. In an example of an author of a website's blog, the other blog posts from that website may form some context for the author working on a new blog post.

The user's text input may be received in block 310. The user may create or otherwise generate text for their document. The text that an author adds to a document may be the relevant text for the author's current focus. For example, an author who writes a specific paragraph may be focused on the topic of that paragraph within the context of the complete document. Because the current text may be the immediate focus of the author's work, the current text may also be the focus of the search being performed against the knowledge graph.

In block 312, the document template, author data, related documents, and the user text input are combined into the larger document. One conceptual framework may be to consider the text being generated as the document and the contextual data, such as author data and related documents, as meta-data or domain information for that document.

Topics may be extracted from the document in block 314. Topics may be any element discussed in the document. An element may be a subject or object of a sentence, but in some cases may also be the verb, participle, or other elements of the sentence. For each topic in block 316, a node may be created on the document graph representing that topic.

For each node in block 320, a loop may be performed for every other node in block 322. Relationships, if any, may be identified between the nodes in block 324 and those relationships may be classified in block 326. Each type of relationship may be processed in block 328, where the relationship strength may be determined in block 330. The relationship may be added to the graph as an edge in block 332.

A search may be performed using the document graph against the knowledge graph in block 334. The results may be received in block 336 and presented to the user in block 338.

When the author adds new text or makes changes to the document in block 340, the process may return to block 310 to re-process the document graph with the updates to the text.

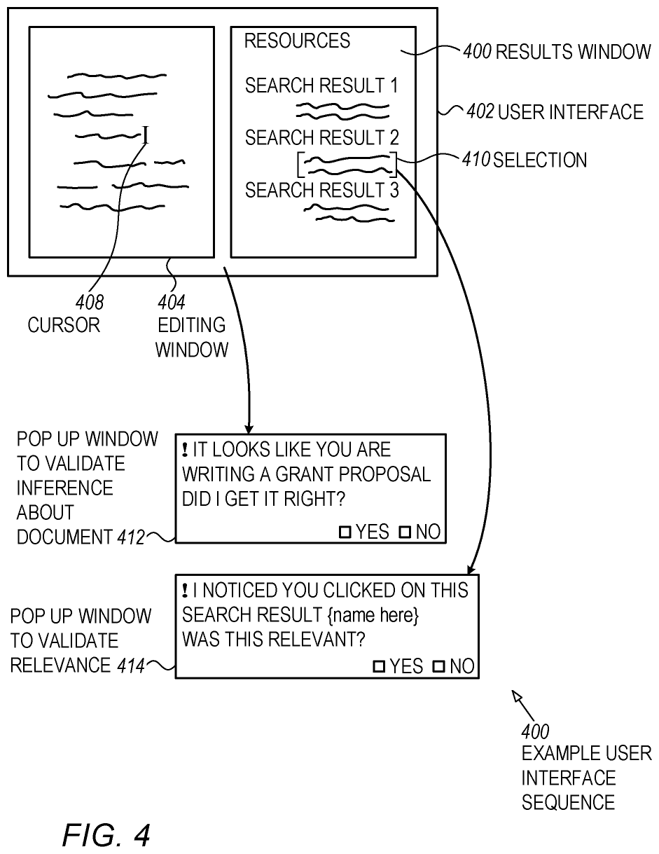

FIG. 4 is a diagram illustration of an embodiment 400 showing example user interface sequences. Embodiment 400 is merely one example of interactions that may be performed with an author who may be creating and editing text.

A user interface 402 may have an editing window 404 and a results window 406. Within the editing window 404, an author may be editing at the location of a cursor 408. An author may also use the cursor 408 to select and highlight blocks of text, such as words, phrases, sentences, paragraphs, and other blocks.

The results window 408 may present search results. The search results may be determined by comparing a document graph to a knowledge graph. In the example of embodiment 400, the author may have made a selection 410, which may have highlighted the second search result.

In one use experience, the comparison of the document graph with a knowledge graph may have implied that the author is working on a grant proposal. In such a case, a pop up window 412 may be presented by the system. The pop up window may indicate that the document appears to be a grant proposal and asks for the author's confirmation. If the author confirms that the document is a grant proposal, the grant proposal information may be added to the document graph. In such a situation, the grant proposal may be metadata that may provide structure and context for the document graph, which may be reflected in the search results from a knowledge graph that contains grant proposal information.

In another use experience, a feedback dialog box may be presented to the author based on one of their selections. In the example, selection 410 is made by an author. The selection 410 may expand by displaying a search result in more detail, displaying a web page from which the result was found, or other information.

The system may present a pop up window 414 to validate the relevancy of the search result. In the window 414, the result was displayed and the author may be asked whether or not the result was relevant to the author's work. If so, similar results may be identified for later searches.

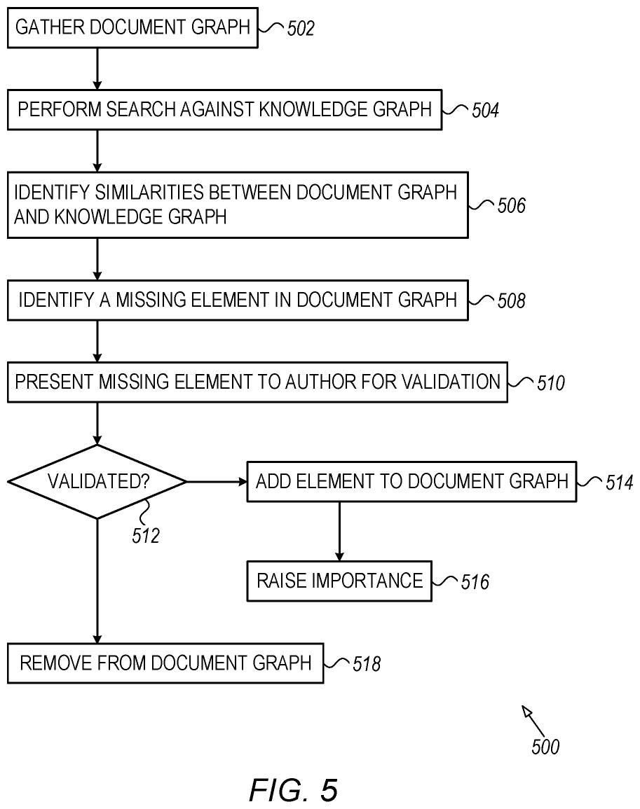

FIG. 5 is a flowchart illustration of an embodiment 500 showing a general method of identifying and validating missing elements between a document graph and a knowledge graph during searching. Embodiment 500 may be a simplified example of the steps that may compare a document graph and a knowledge graph, then infer information from the comparison.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 502, a document graph may be gathered. In many cases, a document graph may include a graph of the document contents as well as metadata about the document. A graph containing document contents may include the words, phrases, topics, and general contents of the document as well as their relationships with each other. The metadata about the document may include graph elements that define the structure, hierarchy, and other information. In many cases, the metadata may include the document purpose or use case, author information, additional documents that may be related to the document, and other metadata.

A search may be performed in block 504 to compare the document graph against the knowledge graph. Similarities between the two graphs may be identified in block 506, and differences may be identified in block 508.

Similarities between the graphs may indicate matches between the graphs. For example, a document graph may include a certain set of topics and specific relationships between those topics, When these topics and relationships are found in the larger knowledge graph, the strength of the similarities shows the strength of the match. When a strong match is found, the neighboring elements within a knowledge graph may be strongly relevant to the document.

A knowledge graph may have elements that may be missing in the document graph. In the example of embodiment 400, a search revealed that the document may have been a grant proposal based on the structure of the document, however, the author may never have explicitly defined the document as such.

A comparison of the structure and content of a document with a knowledge graph may reveal that the document of embodiment 400 appeared to be a grant proposal. This prompted the system to present the missing element to the author, as in block 510, to validate the element.

The author may validate the missing element in block 512, after which the element may be added to the document graph in block 514 and the importance of the newly added element may be raised in block 516.

If the missing element is not validated in block 512, the element is removed from the document graph in block 518.

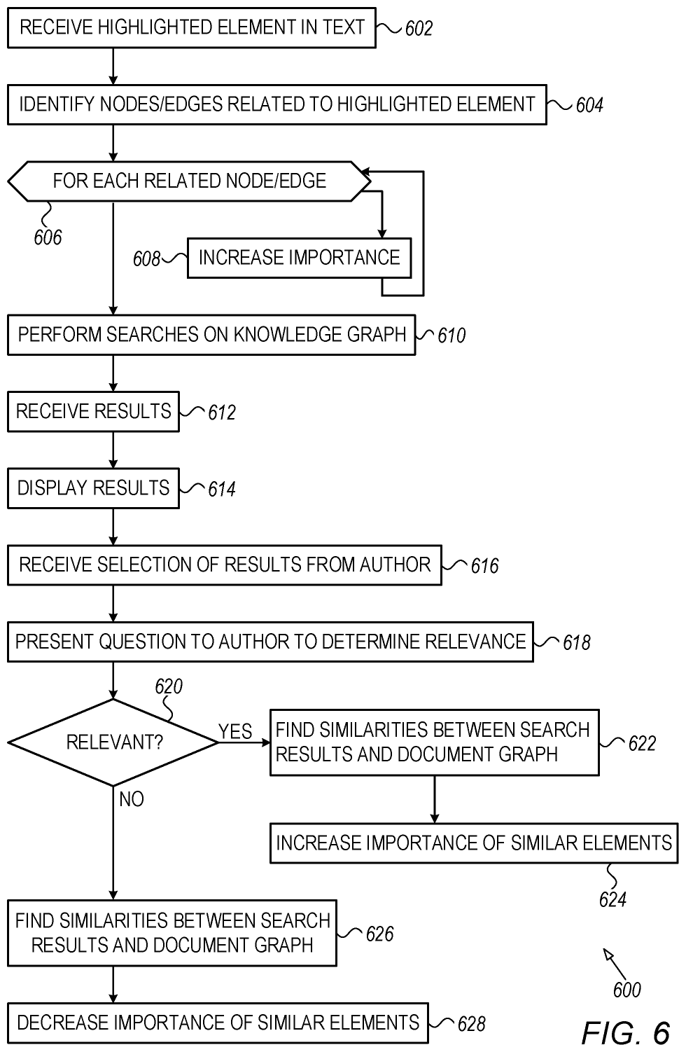

FIG. 6 is a flowchart illustration of an embodiment 600 showing a general method of performing searches using document graphs and adjusting relevancy with user feedback.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A system may receive highlighted text in block 602. The highlighted text may be a selection of a word, phrase, sentence, paragraph, or other portion of text. In some cases, the default highlighted text may be the last word, sentence, or paragraph that an author has written.

The nodes and edges of the highlighted text within the document graph may be identified in block 604 and for each node or edge in block 606, the importance of those nodes and edges may be raised in block 608.

A search may be performed against the knowledge graph in block 610, where the matching algorithm may prioritize matches with the nodes and edges of higher importance. The results may be received in block 612 and displayed in block 614.

One of the results may be selected by the author in block 616.

A question may be presented to the author in block 618 to determine the relevance of the selected search result. If the result is relevant in block 620, the similarities between the search results and the document graph may be identified in block 622 and those elements may have an importance value increased in block 624.

If the results are not relevant in block 620, the similarities between the document graph and search results may be identified in block 626 and those elements may have their importance value decreased in block 628.

The process of refining the importance values of different elements within the document graph may improve later search results by better matching the author's intent with elements in the knowledge graph.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A device comprising:
at least one processor, said at least one processor configured to execute a text editor, said text editor comprising:
a text editor window configured to receive text input, display said text input, and edit said text input;
a search results window configured to display search results;
a search manager that performs a method comprising:
builds a document graph from said text input, said document graph comprising document nodes defined by topics and document edges defined by relationships between said topics, at least some of said topics being derived from said text input;
identifying a first portion of said text input, said first portion comprising a first document node;
causing a first search to be performed using said first portion of said first text input to receive a first set of search results, said first search comprising comparing said first portion with a knowledge graph; and
causing said first set of search results to be displayed in said search results window.

2. The device of claim 1, said text editor further configured to:
select a portion of said first set of search results from said search results window and paste said portion of said first set of search results into said text editor.

3. The device of claim 2, said portion comprising text retrieved in said first set of search results.

4. The device of claim 3, said portion being added to said text editor window and applying a formatting style to said portion, said formatting style indicating a quote.

5. The device of claim 4, said text editor further configured to add a reference link to said portion, said reference link being a source for said quote.

6. The device of claim 2, said portion comprising a link to a document retrieved in said first set of search results.

7. The device of claim 1, said identifying a first portion of said text input occurring while a user is entering said text input.

8. The device of claim 1, said text input comprising a paragraph, and said first portion of said text input being a topic of said paragraph.

9. The device of claim 1, said text input comprising a plurality of paragraphs, said method further comprising:
detecting an edit in a first paragraph within said plurality of paragraphs and identifying said first portion of said text input within said first paragraph.

10. The device of claim 1, said identifying a first portion of said text input by detecting a highlight function by said user of said first portion.

11. The device of claim 1, said first portion being not more than 10% of said text input.

12. The device of claim 1, said text editor further configured to receive a template, said template comprising document sections for a document.

13. The device of claim 12, said method further comprising:
analyzing said document sections to identify a first document section having less than a predetermined amount of text, said document section having a descriptor;
causing a second search to be performed using said descriptor and at least a second text portion of said text input and receiving a second set of search results, said second set of search results comprising information directed to said first document section; and
causing said second set of search results to be displayed in said search results window.

14. The device of claim 1, said search results window having search results input mechanism adapted to:
receiving at least one modifier for said search results from said search results input mechanism;
causing a second search to be performed using said modifiers and receiving a second set of search results; and
causing a second set of search results to be displayed in said search window.

15. The device of claim 14, said modifier comprising a first selection of said text input, said first selection being a focused topic for said second search and being a subset of said first portion of said text input.

16. The device of claim 14, said modifier comprising a first selection of a primary subject and a second selection of a context for said primary subject.

17. The device of claim 16, said primary subject being derived from said first portion of said text input and said context being derived from a second portion of said text input.

18. The device of claim 16, said second portion of said text input comprising text that is not said first portion of said text input.

19. The device of claim 18, said first portion and said second portion being selected automatically.

20. The device of claim 18, at least one of said first portion and said second portion being selected automatically.
